(19) United States
(12) Patent Application Publication
(10) Pub. No.: US 2006/0080875 A1
(43) Pub. Date: Apr. 20, 2006

(54) Semi-opaque vehicle for sale sign

(75) Inventors: Mel T. Nelson, Denver, CO (US); Charles Michael Cotsworth, Parker, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Cruise Route 66, Englewood, CO (US)

(21) Appl. No.: 10/966,730

(22) Filed: Oct. 15, 2004

(51) Int. Cl. G09F 21/04

(52) U.S. Cl. 40/593

(57) ABSTRACT

A semi-opaque vehicle sign adapted for at least partial placement in the window of a vehicle. One can view through the sign from the vehicle interior. The sign includes a first indicia visible from outside the vehicle that the vehicle is for sale, for rent or for lease. A second indicia uniquely identifies the vehicle sign within a population of vehicle signs. The second indicia can be used in some embodiments to make an inquiry to an information exchange for information about the vehicle.

This application is related to U.S. patent application Ser. No. ______, filed on the same date as the present application, entitled “VEHICLE IDENTIFICATION SYSTEM” (temporarily referenced by Attorney Docket No. 40286-000200US), which is incorporated by reference in its entirety for all purposes.

### BACKGROUND OF THE DISCLOSURE

The present disclosure relates to the field of visual identification of a vehicle and, more specifically, but not by way of limitation, to using numbers, letters, symbols, or other variable indicia visible from outside the vehicle for identification. Examples include: license plates attached to a motor vehicle used on public roads; numbers, symbols, and/or letters on the tail of an aircraft, on the hull of a boat, or on the side of a rail car; signs attached to a vehicle; and automotive vehicle identification numbers visible through a windshield.

The present disclosure also relates to the advertising and graphics arts field, particularly to the use of advertising signs attached to a vehicle that identify that the vehicle is for sale. Conventional signs typically include a contact reference that a prospective purchaser can query to learn more about the vehicle or to make an offer to purchase it.

Additionally, the present disclosure relates to the use of semi-opaque films used to “wrap” all or part of a vehicle. Such films typically display advertising visible from the vehicle exterior that is generally not visible from the vehicle interior. Such films can also be used to “wrap” opaque body parts of the vehicle such as the doors, hood, and fenders. Window films and vehicle body films can conventionally be combined to provide a complete “wrap” of a vehicle.

According to the U.S. Bureau of Transportation Statistics (www.bts.gov), there were the following numbers of passenger vehicles and trucks on the road as of 2001:
Passenger cars: 137,633,467
Sport utility vehicles (other 2-axle 4-tire vehicles): 84,187,636
2-axle 6-tire or more trucks: 5,703,500
Combination trucks: 2,154,174
TOTAL 228,678,777
   Passenger cars and trucks represent the majority of the vehicles registered in the U.S.A. Among the other types of vehicles identified by the Bureau of Transportation statistics were air transport vehicles (both general aviation and air carrier), transit vehicles (including motor buses and trolley buses), rail vehicles (including passenger and freight cars and locomotives), and water vehicles (including recreational boats and non-self-propelled vessels).

The U.S. Bureau of Transportation Statistics also identified that in 2001, 42,624,000 used passenger cars (31% of total registered passenger cars) were sold. If this same percentage is applied to sport-utility vehicles, and trucks, and if 2001 is a typical year, it would mean that over 70 million used vehicles are sold each year. In addition, the U.S. Bureau of Transportation statistics identified that over 12.5 million new passenger cars and sports utility vehicles are sold each year. The primary conventional ways for buying and selling vehicles are:
a. Dealerships, where customers can view, compare, and purchase new and used vehicles;
b. Advertisements in a general circulation newspaper, advertisements in a specialty paper or magazine such as Auto Trader™, or listings on the internet where customers can remotely review vehicles, but not directly see them; or
c. Signs placed on a vehicle identifying that the vehicle is for sale. The vehicle is then used normally or parked in a conspicuous location, such as a parking lot near a busy intersection.

It is estimated that just over 50% of used vehicles are sold through dealers. The others are presumably sold primarily through advertisements in the newspaper, listings on the internet, or by placing signs on the vehicle. See answers.google.com/answers/threadview?id=146894. Because of the many vehicles for sale at any particular time and the need for a prospective buyer to “see the vehicle”, many vehicles (especially used vehicles) are sold through “for sale” signs placed on the vehicle. Prior art vehicle “for sale” signs are opaque. Because they are opaque and typically placed in a vehicle window, they must be small enough not to block the vehicle driver's view or violate local statute. Typically they are 9 inches tall by 12 inches wide, or smaller. The signs are generally red, white, and black in color and made of a substantially stiff material. It is possible to mount a sign on parts of a vehicle other than its windows, but on cars, trucks, and sports utility vehicles these areas tend to be less visible to other drivers because they are lower on the vehicle, or more difficult to attach to because many vehicle body parts are not substantially flat. As a result, prior art vehicle for sale signs suffer from at least the following limitations:

a. The sign typically includes a pre-printed message, such as the words “For Sale”, and handwritten contact information, such as a 7-digit or 10-digit phone number. This handwritten information is too small to be read from a distance, such as when you are driving behind a vehicle. Typically the hand-written numbers and letters are about 1 inch (25mm) tall. This compares to numbers on a license plate, which are typically 2-3 inches (50-75 mm) tall and the information on a street sign, which is typically at least 4 inches tall.

b. Even if you could read the information on the sign, the amount of information a prospective buyer needs to remember (typically a 7 or 10-digit phone number) cannot easily be memorized. A prospective buyer would need to write this contact reference down if they want to further investigate this vehicle, something that cannot easily be done while driving down the road.

c. Vehicle buyers often want more information about the vehicle than they can visually recognize when viewing the vehicle exterior from a distance. They also want other facts such as the asking price and the mileage. In some cases, the vehicle seller will write the vehicle mileage, year, or desired selling price on the small sign. This information is also too small to be read from a distance. The facts provided are usually also insufficient for a vehicle buyer to decide whether they are interested. As a result, the buyer must typically phone the seller (who is often not home) in order to get additional information.

### BRIEF DESCRIPTION OF THE DRAWINGS

The present disclosure is described in conjunction with the appended figures:

FIG. 1A is a semi-opaque vehicle for sale sign mounted on a vehicle;

FIG. 1B is another semi-opaque vehicle for sale sign mounted on a vehicle;

FIG. 2 is a cross-section of the semi-opaque vehicle for sale sign mounted on a vehicle window;

FIG. 3 is a fabrication and installation process for a semi-opaque vehicle for sale sign;

FIG. 4A is a block diagram of an information exchange interacting with a seller and a shopper/buyer;

FIG. 4B is a block diagram of another information exchange;

FIG. 4C is a block diagram of a third information exchange;

FIG. 5A is a diagram explaining a database;

FIG. 5B is another diagram explaining a database;

FIG. 6 is a flow diagram of a vehicle for sale registration process; and

FIG. 7 is a flow diagram of a vehicle for sale inquiry process that can be initiated by a shopper/buyer who has seen a vehicle for sale and that can output vehicle fact(s) for a specific vehicle identified.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF THE PREFERRED EMBODIMENT

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments maybe practiced without these specific details. For example, circuits may be shown in block diagrams in order not to obscure the embodiments in unnecessary detail. In other instances, well-known circuits, structures and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc.

Moreover, as disclosed herein, the term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The present disclosure explains ways to facilitate the sale, rent and/or lease of a vehicle in various embodiments. This can include the sale of a new vehicle or a used vehicle. It can include the sale of a vehicle through a dealer or a private party sale. A vehicle can be a means for conveying people or freight on land—as in a rail car, a highway vehicle or a sled. A vehicle can be a means for conveying people or freight on water—as in a powered boat or a towed barge. A vehicle can be a means for conveying people or freight through the air—as in a commercial aircraft or a glider. A vehicle can be a means for conveying people or freight through space—as in a launch vehicle used to place a satellite into orbit.

Embodiments can include a sign. The sign can be on the interior of a vehicle and visible through a window; it can be attached to the exterior of a window; it can be attached to a part of the vehicle that is not a window; or it can span both a window and other parts of the vehicle that are not windows. The sign can be used only when the vehicle is stationary, it can be used only when the vehicle is in motion; or it can be used both when the vehicle is stationary and when it is in motion. One embodiment can incorporate an information exchange. The information exchange can be any type of system that can process a query from a shopper, interested party or prospective car buyer. The query can be a voice query, a written query on paper, or a gesture. In other embodiments, the query can be any type of request for information sent electronically by means of voice, video, facsimile, or any other form of electronic data transmission.

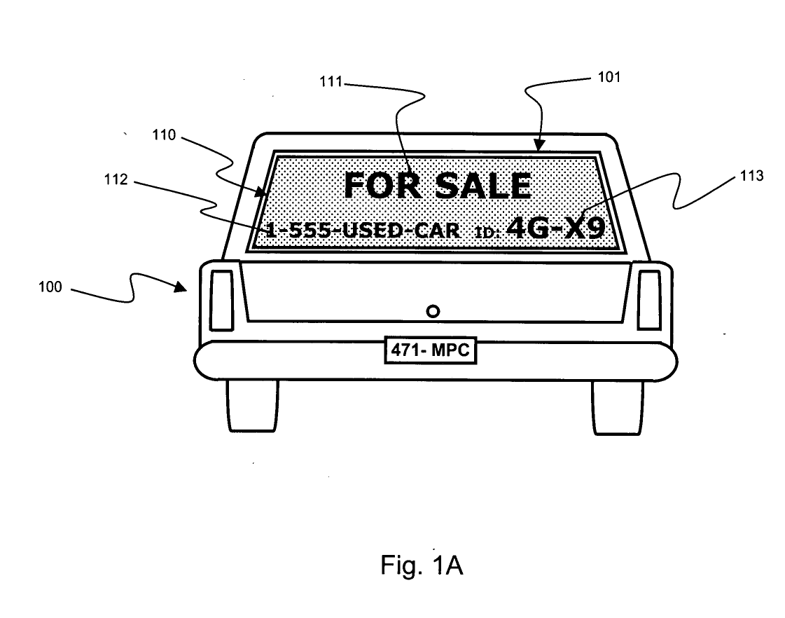

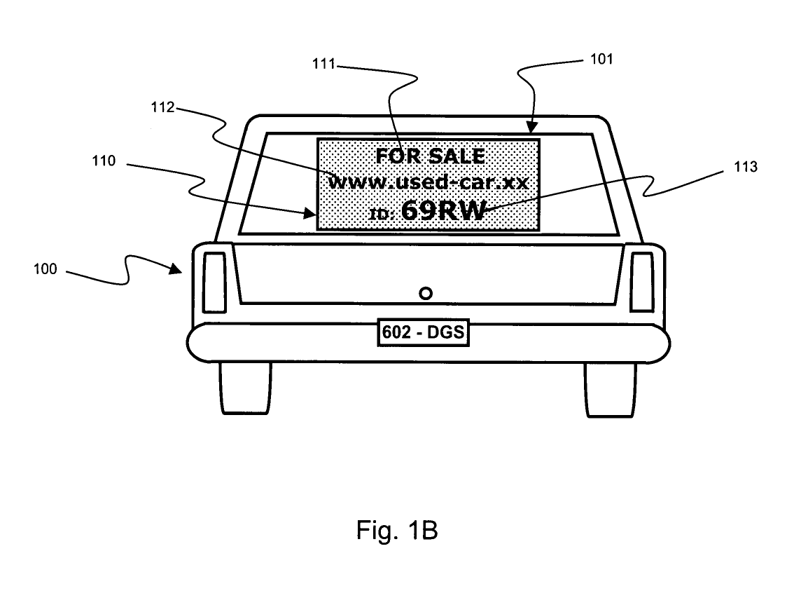

Referring first to FIG. 1A a semi-opaque vehicle for sale sign 110 is shown mounted on a vehicle 100. The vehicle 100 has a window 101. In this particular case, the rear window has been shown. Embodiments can also be applied to other windows of the vehicle 100 or to non-transparent parts of the vehicle 100. The semi-opaque vehicle for sale sign 110 has a message, in this case the words “FOR SALE”, shown at 111. This message can be written in any language capable of being understood by a potential vehicle buyer. The vehicle sign 110 includes a contact reference, shown at 112. In this example, the contact reference 112 is an 11-digit telephone number that is easily memorized because: the first four digits are a standard sequence and the last seven digits represent an easily memorized phrase or brand name associated with vehicle sales.

The vehicle sign 110 further includes variable indicia, shown at 113. The variable indicia, 113, are sufficiently large to be visible from a distance and the total quantity of indicia, 113 are sufficiently few as to be easily memorable until one can write them down. The indicia 113 is said to be variable because a population of signs is produced with each sign having a unique indicia 113. The population in various embodiments could be at least 10,000, 25,000, 50,000, 75,000, 100,000, 150,000, 200,000, 250,000, 300,000, 500,000, 750,000, 1 million, 2 million, 5 million, or 10 million. In various embodiments, there can be a maximum of 3, 4, 5, 6, 7, 8, 9, 10, or 11 symbols in variable indicia 113.

According to the eye chart developed by Hermann Snellen in 1862 and still used by optometrists today, a person with normal vision can read normally-formed high-contrast 2.5-inch high letters and numbers, the minimum size used on a typical car license plate, at a maximum distance of 150 feet. This same person can read 4-inch high letters and numbers, typically used on a street name sign, at a maximum distance of 240 feet. The 1-inch high phone number on a typical vehicle for sale sign would be readable at 60 feet, if it is well written. Using the 2-second rule for following a vehicle, one should be at least 150 feet behind another vehicle at 50 miles per hour and at least 90 feet behind another vehicle at 30 miles per hour. This means that the contact information on a typical prior art vehicle for sale sign is not readable when following this vehicle. The numbers on the rear license plates are barely readable by someone with 20/20 vision driving 2 seconds behind another car at typical highway speeds.

The size of the variable indicia 113 is dependent upon the desired distance from which these indicia will be readable. In various embodiments, the variable indicia can have a minimum height of 2, 2.25, 2.5, 2.75, 3, 3.25, 3.5, 3.75, or 4 inches. The width is at least 0.5 inches in one embodiment. In various embodiments, the variable indicia are readable under normal conditions from a maximum distance of 90, 100, 125, 150, 200, or 250 feet.

FIG. 1A shows another semi-opaque vehicle for sale sign, shown at 110 mounted on another vehicle, shown at 100. In this example, the contact reference is a worldwide web address or URI. As shown by FIG. 1A and FIG. 1B, the semi-opaque vehicle for sale sign 110, can be of varying size and shape. The semi-opaque vehicle for sale sign 110 can be a minimum of 100 square inches in one embodiment. In various other embodiments, the semi-opaque vehicle for sale sign 110 can be a minimum of 125, 150, 175, 200, 225, or 250 square inches.

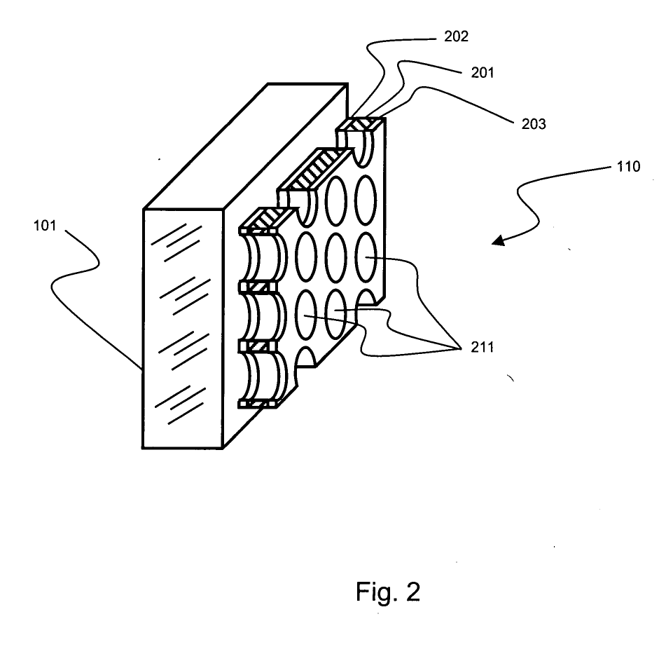

FIG. 2 shows a cross-section of the semi-opaque vehicle for sale sign 110 mounted on an exterior surface of the vehicle window 101. There are many materials and layering structures that can be used for such semi-opaque vehicle for sale signs 110, for example, perforated material, tinted material, translucent metallic coating, one-way mirror coating, etc. The semi-opaque vehicle for sale sign 110 can be mounted to the interior or exterior surface of the vehicle window 101. The semi-opaque vehicle for sale sign 110 can be freestanding or be mounted to something else that is placed inside or outside of the vehicle window 101. The semi-opaque vehicle for sale sign 110 could be mounted to a non-transparent part of a vehicle 100 or partially mounted over a window and partial mounted over a non-transparent part of the vehicle 100. The semi-opaque vehicle for sale sign 110 could be mounted to a combination of a vehicle window 101 and a non-transparent part of the vehicle 100.

The semi-opaque vehicle for sale sign 110 in the depicted embodiment is made from an Avery Dennison™ MPI 4002 Gloss perforated window film. This is a vinyl film that comes pre-perforated with 1/16″ round holes 211 on 3/32″ spacing in a hexagonal configuration giving 80% open area for light transmission which equates to an average 80% visible light transmittance. Different perforation patterns could have different visible light transmittance.

Some embodiments could have a portion of the sign that may or may not be perforated that allows writing contact information such as a phone number, an e-mail address, a electronic message address, or a web address that viewers can use to contact the sign holder. The portion on a tinted or mirrored sign could have the portion be printed with an opaque area that would allow the contact information to be read more easily.

Different states, municipalities, countries or jurisdiction can have different laws regarding the minimum transmittance allowed through a window and these laws can vary from window to window in a car. For purposes of this patent application, light transmittance is defined as the percentage of visible light that passes through a sign as a percentage of the visible light incident on the sign averaged over the sign area. A lower transmittance translates to a “darker” appearing window. In various embodiments, the transmittance for the semi-opaque vehicle for sale sign 110 can be a minimum of 15%, 18%, 20%, 25%, 27%, 28%, 30%, 32%, 33%, 35%, 40%, 43%, 50%, 70%, or 80%.

In some embodiments, only some of the sign 110 could be translucent. For example, the lettering might not be perforated such that it is opaque. Some embodiments might have an opaque border around a perforated or translucent section. A portion of the sign could have no perforations to allow writing on that portion more easily. A sign could have a portion that is perforated and a portion that is translucent tinting. In another embodiment, the sign could be partially translucent and partially not where the translucent portion is meant for mount over the window and the opaque portion is mounted over a part of the vehicle other than a window. In various configurations, at least 50%, 60%, 70%, 75%, 80%, 85%, 90%, or 95% of the sign surface area could be translucent with the remainder being opaque.

After fabricating and mounting on the vehicle window 101, the semi-opaque vehicle for sale sign 110 has a minimum of three layers in this embodiment. A substrate is a middle layer, shown at 201, typically a plastic film made of polyvinyl chloride. An adhesive layer is another layer, shown at 202, for attachment to the vehicle window 101. An information layer, shown at 203, can be created using a Vutek™ solvent-based ink on a Vutek™ inkjet printer. There are other methods that can be used to create this information layer 203, including but not limited to screen printing, electrostatic printing, manual printing, hand writing, painting, and/or laminating.

Semi-opaque vehicle for sale signs 110 can be constructed using many different layering structures. Various embodiments can incorporate any of these layering structures. In order to provide a semi-opaque properties, the surface of the sign facing the vehicle interior can be dark colored (i.e. have a substantially light-absorbing appearance) to contrast with the light coming through the sign. Some of the known ways to make the dark interior-facing surface include: (1) using a light-absorbing adhesive layer 202 that has holes to allow light through; (2) using a transparent or translucent adhesive layer 202 and a light-absorbing substrate 201 with holes to let light through; and/or (3) using a transparent or translucent adhesive layer 202 and an additional light-absorbing layer with holes to let light through between the substrate 201 and the adhesive layer 202.

In various embodiments, the substrate 201 can be transparent or translucent and perforated. The substrate 201 can be opaque and perforated in other embodiments. The substrate 201 can be non-perforated and transparent or translucent as long as it meets legal transparency requirements for the vehicle window 101 and as long as the sign 110 has a dark surface facing the interior of the vehicle in the non-transparent areas. The exterior-facing surface of the sign 110 contains information that is visible primarily from the exterior of the vehicle. This exterior surface can be one layer or it can be multiple layers in various embodiments. For contrast and visibility, this exterior surface can be of a white or other highly reflective under-layer that is then has the information layer 203 applied over it. If the substrate 201 is opaque with perforations and has a high reflectance or light color, the substrate can serve as the highly reflective under-layer. In this case it is possible to build the semi-opaque vehicle for sale sign 110 using only three layers, a black adhesive layer 202 a white, light colored, or metallic substrate 201 and an exterior-facing information layer 203. In this case, the perforations go all the way through the adhesive layer 202, the substrate 201, and the information layer 203. Often an additional clear layer can be applied over the information layer 203. In one embodiment, this clear layer does not contain perforations because perforated surfaces as susceptible to the buildup of dirt and snow in the perforations. If the semi-opaque vehicle for sale sign 110 is to be applied to the interior of the vehicle window 101, the order and composition of the layers would be different, but can be understood by anyone skilled in the art.

In one embodiment, the resulting semi-opaque vehicle for sale sign 110 is made to be capable of standing up the environment found in a vehicle that is parked, unheated, un-cooled, and susceptible to a broad range of humidity, a typical specification can be a temperature range from −40° F. to +120° F. and relative humidity ranging from 5% to 98%. The typical environment can also include a high amount of ultraviolet radiation from the sun. The semi-opaque vehicle for sale sign 110 in various embodiments can have a minimum lifetime in this environment of 2 weeks, 4 weeks, 8 weeks, 16 weeks, one-half year, or one year.

The resulting semi-opaque vehicle for sale sign 110 is typically thin enough to be flexible. This makes it possible for the semi-opaque vehicle for sale sign 110 to conform to the curved shape of a vehicle window 101 or some other part of a vehicle 100 to which the for sale sign 110 is attached. In various embodiments, the semi-opaque vehicle for sale sign 110 can be a maximum average thickness of 0.020, 0.040, 0.060, 0.080, 0.100, 0.150, 0.200, 0.400, or 0.600 inches.

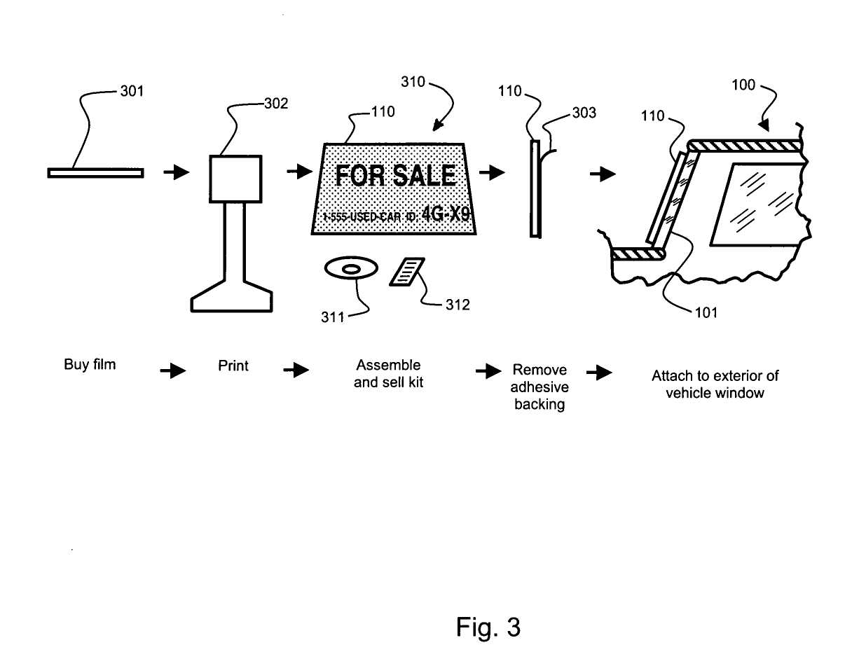

FIG. 3 shows a fabrication and installation process for a semi-opaque vehicle for sale sign 110. Referring to FIG. 3, a one-way see through sign material or semi-opaque material, such as Avery Dennison™ MPI 4002, is shown at 301. The information layer, 203 in FIG. 2, can be added to one-way see through sign material 301 using a printer, such as a Vutek™ UltraVu 150™ solvent-based inkjet printer, shown at 302. The resulting semi-opaque vehicle for sale sign, shown at 110 can be combined with electronic media, shown at 311, and printed media, shown at 312, into a vehicle sign kit, shown at 310. The vehicle sign kit 312 can also be contain variable indicia 113 in FIG. 1A and FIG. 1B, a message that means “FOR SALE” in a language capable of being understood by a potential buyer 111 in FIG. 1A and FIG. 1B, and/or a contact reference 112 in FIG. 1A and FIG. 1B, where one or more of these elements are provided “loose” to the buyer of the kit, who then assembles the sign himself or places these elements directly on the vehicle. The kit could be sold at a retail store or ordered online. In one embodiment, the kit is sold as part of a package that includes listing the vehicle in electronic and/or print classifieds.

Referring further to FIG. 3, the adhesive backing, shown at 303, can be separated from the semi-opaque vehicle for sale sign, 110 when the sign 110 is mounted on the vehicle window 101. The electronic media 311 and/or the printed media 312 can be used to provide information that facilitates the process for mounting the sign 110 on the vehicle window 101. The sign could be mounted in a number of ways, for example, using adhesive over part or all of the sign, using suction cups, with magnets at the periphery of the sign, by wedging part of the sign between the top of the window and the mating channel, or other ways. In one embodiment, the adhesive is largely removed when the sign is pulled off the window.

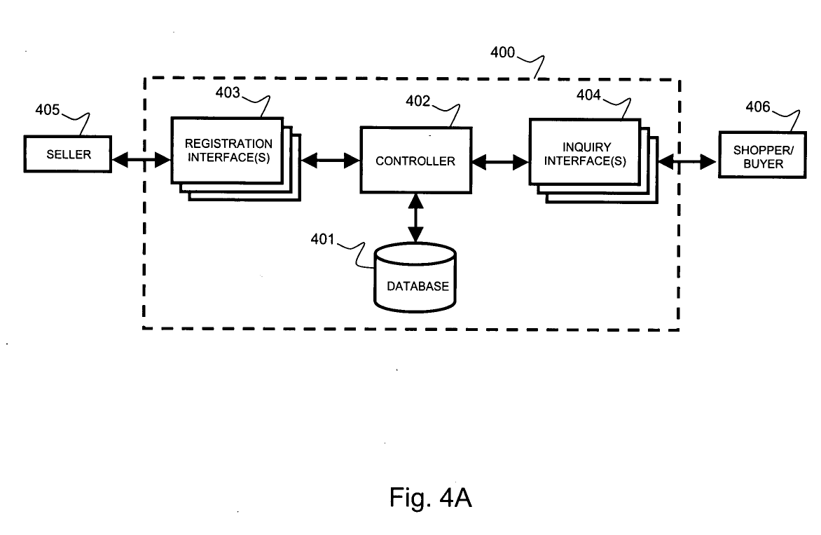

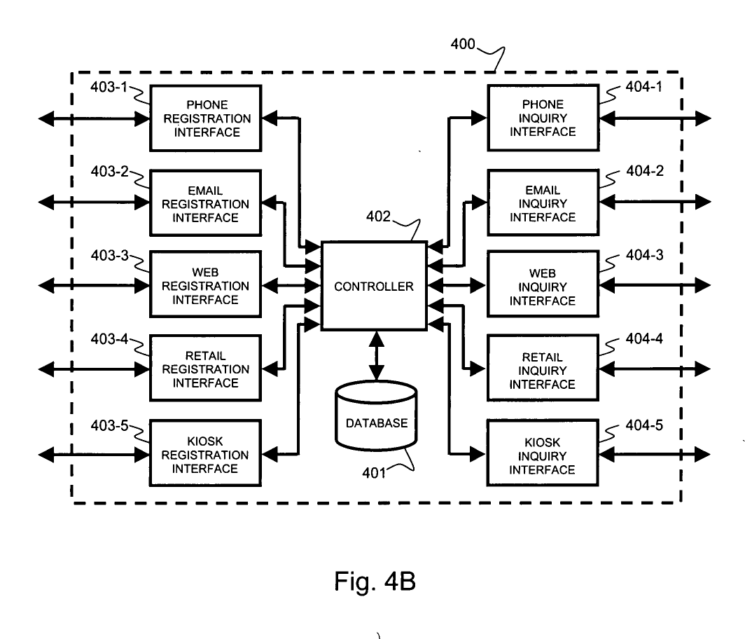

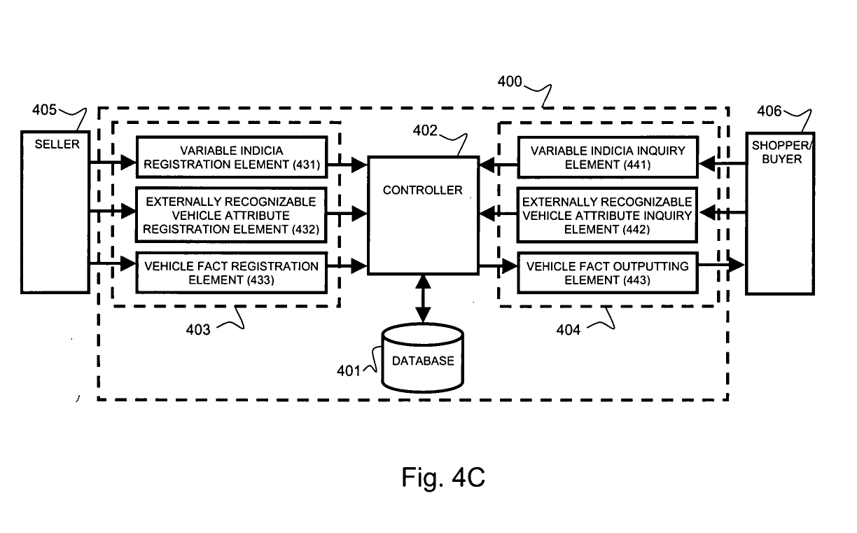

FIG. 4A and FIG. 4C show a block diagram of an information exchange 400 that can interact with a seller 405 and a shopper/buyer 406. The information exchange 400 includes a registration interface or interfaces 403 to connect to the seller 405 and an inquiry interface or interfaces 404 to connect to the shopper/buyer 406. The information exchange also includes a database, shown at 401. A controller 402 connects the registration interface(s) 403 and inquiry interface(s) 404 to the database 401. Each of these elements can be implemented manually and/or automatically. If these elements are implemented automatically, each of these elements can be implemented mechanically and/or electronically. If these elements are implemented electronically, each of these elements can be implemented in hardware and/or in software. If these elements are computer-implemented, each of these elements can exist on a single computer or they can exist in pieces on multiple computers that are connected together. The elements can be separate or they can be integrated.

FIG. 4B shows a block diagram of another information exchange 400 and some of the types of registration interfaces 403 that can be part of the information exchange 400. The information exchange 400 can include a phone registration interface 403-1 that allows the seller to register a vehicle for sale over the phone. The information exchange 400 can include an email registration interface 403-2 that allows the seller to register the vehicle for sale using an email message. The information exchange 400 can include a web registration interface 403-3 that allows the seller to register the vehicle for sale using the world wide web, typically be logging on to a website over the internet. The information exchange 400 can include a retail registration interface 403-4 that allows the seller to register the vehicle through a retail outlet. The information exchange 400 can include a kiosk registration interface 403-5 that allows the seller to register the vehicle for sale using a kiosk that is electronically tied to the controller 402. The information exchange 400 can have a FAX registration interface. The information exchange 400 can have a mail registration interface.

FIG. 4B also shows some of the types of query interfaces 404 that can be part of the information exchange 400. The information exchange 400 can include a phone query interface 404-1 that allows a shopper/buyer to find out information about a specific vehicle for sale over the phone. The information exchange 400 can include an email query interface 404-2 that allows the shopper/buyer to find out information about the specific vehicle for sale using an email message. The information exchange 400 can include a web query interface 404-3 that allows the shopper/buyer to find out information about the specific vehicle using the world wide web, typically be logging on to a website over the internet. The information exchange 400 can include a retail query interface 404-4 that allows shopper/buyer to learn more about the specific vehicle for sale by contacting a retail outlet. The information exchange 400 can include a kiosk registration interface 404-5 that allows the shopper/buyer to find out more about the specific vehicle for sale using a kiosk that is electronically tied to the controller 402. The information exchange 400 can have a FAX query interface. The information exchange 400 can have a mail query interface.

FIG. 4C also shows possible elements of the registration interface(s) 403 and inquiry interface(s) 404. The registration interface 403 can include a variable indicia registration element 431 that can transmit variable indicia from the seller 405 to the controller 402. The registration interface 403 can include an externally recognizable vehicle attribute registration element 432 that can transmit one or more externally recognizable vehicle attributes from the seller 405 to the controller 402. The registration interface 403 can include a vehicle fact registration element 433 that can transmit one or more vehicle facts from the seller 405 to the controller 402. The inquiry interface 404 can include a variable indicia inquiry element 441 that can transmit variable indicia from the buyer 406 to the controller 402. The inquiry interface 404 can include an externally recognizable vehicle attribute inquiry element 442 that can transmit one or more externally recognizable vehicle attributes from the buyer 406 to the controller 402. The inquiry interface 404 can include a vehicle fact outputting element 443 that can transmit one or more vehicle facts from the controller 402 to the buyer 406.

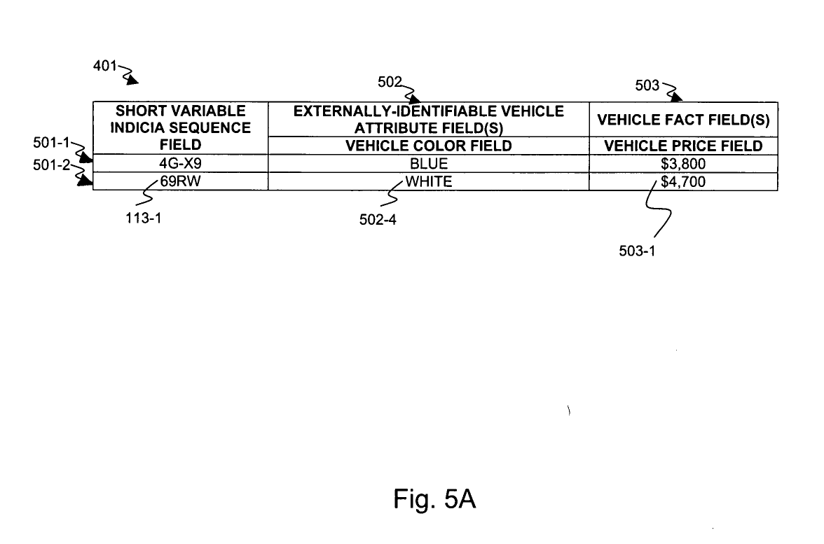

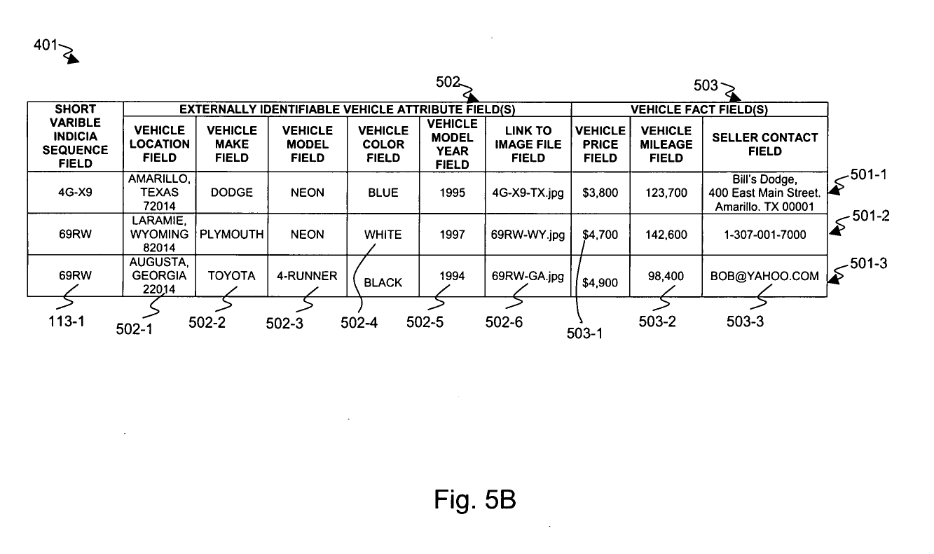

FIG. 5A and FIG. 5B provide diagrams explaining the database, 401 in FIG. 4A and FIG. 4B. The database 401 can contain a plurality of records, shown by 501-1, 501-2, and 501-3. The records 501 can be composed of a plurality of fields, shown by the cells or columns in FIG. 5A and FIG. 5B. The database 401 can have a short variable indicia field that stores the short variable indicia sequence 113. The database 401 can have one or more fields that store externally identifiable vehicle attributes 502 such as a vehicle location 502-1, a vehicle make 502-2, a vehicle model 502-3, a vehicle color 502-4, and a vehicle model year 502-5. The database can also store images of the vehicle for sale or it can store links to images 502-6 as part of its externally identifiable vehicle attribute fields 502. The database 401 can have one or more fields that store vehicle facts 503 such as a vehicle price 503-1, a vehicle mileage 503-2, and a seller contact 502-3.

Referring further to FIG. 5B, the database 401 can store multiple records 501 that have the same short variable indicia 113. This allows the same short variable indicia 113 to be used concurrently for vehicles that have different externally identifiable vehicle attributes 502. If more than one vehicle for sale has the same short variable indicia sequence 113, externally identifiable vehicle attributes 502 can be used to discriminate between vehicles. This allows the short variable indicia sequence 113 to be significantly shorter than if each short variable indicia sequence 113 could only be used on one vehicle 100. This also allows multiple for sale signs 110 with identical variable indicia 113 to be fabricated at the same time and distributed in a geographically random fashion.

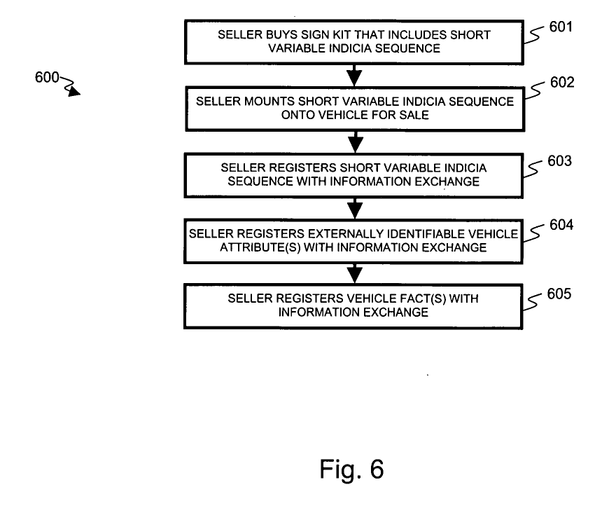

FIG. 6 shows a flow diagram of a vehicle for sale registration process 600 that can be executed between the seller 405 and the registration interface 403 in the information exchange 400. The order of the steps in this process can be varied. The process can start with the seller buying the vehicle sign kit 310 that includes a short variable indicia sequence 113, a step shown at 601. Alternatively, the process can start with the seller buying a semi-opaque vehicle for sale sign 110 that includes the short variable indicia sequence 113.

The seller can then mount the short variable indicia sequence onto the vehicle for sale, a step shown in 602. Alternatively, the seller can mount the for sale sign 110 on the vehicle to be sold. The seller can also combine steps 601 and 602 by making a for sale sign by mounting the message 111 in FIG. 1A or FIG. 1B, the contact reference 112 in FIG. 1A or FIG. 1B, and a short variable indicia sequence 113 in FIG. 1A or FIG. 1B on the vehicle. It is possible that the vehicle 100 in FIG. 1A and FIG. 1B is also the sign 110 in FIG. 1A and FIG. 1B.

The seller registers the short variable indicia sequence 113 with the information exchange 400 using the registration interface 403, a step shown at 603. The seller registers externally recognizable vehicle attribute(s) 502 with the information exchange 400 using the registration interface 403, a step shown at 604. These externally recognizable vehicle attribute(s) 502 can include the location of the vehicle 502-1. These externally recognizable vehicle attribute(s) 502 can include the make or brand of the vehicle 502-2, such as Chevrolet™, Toyota™, or Cessna™. These externally recognizable vehicle attribute(s) 502 can include the model of the vehicle 502-3, such as Malibu™, Camry™, or 210P™. These externally recognizable vehicle attribute(s) 502 can include the color of the vehicle 502-4. These externally recognizable vehicle attribute(s) 502 can include the model year of the vehicle 502-4. These externally recognizable vehicle attribute(s) 502 can include an image of the vehicle.

The seller registers other vehicle facts with the information exchange 400 using the registration interface 403, a step shown at 605. This can include registering the vehicle mileage 503-2, registering the asking price 503-1 of the vehicle, and registering seller contact information 503-3.

The electronic media 311 in FIG. 3 and/or the printed media 312 in FIG. 3 can be used to facilitate the vehicle for sale registration process 600. For example, the electronic media can be a CD-ROM that automatically uploads the short variable indicia sequence 113 on the sign 110 to the information exchange 400.

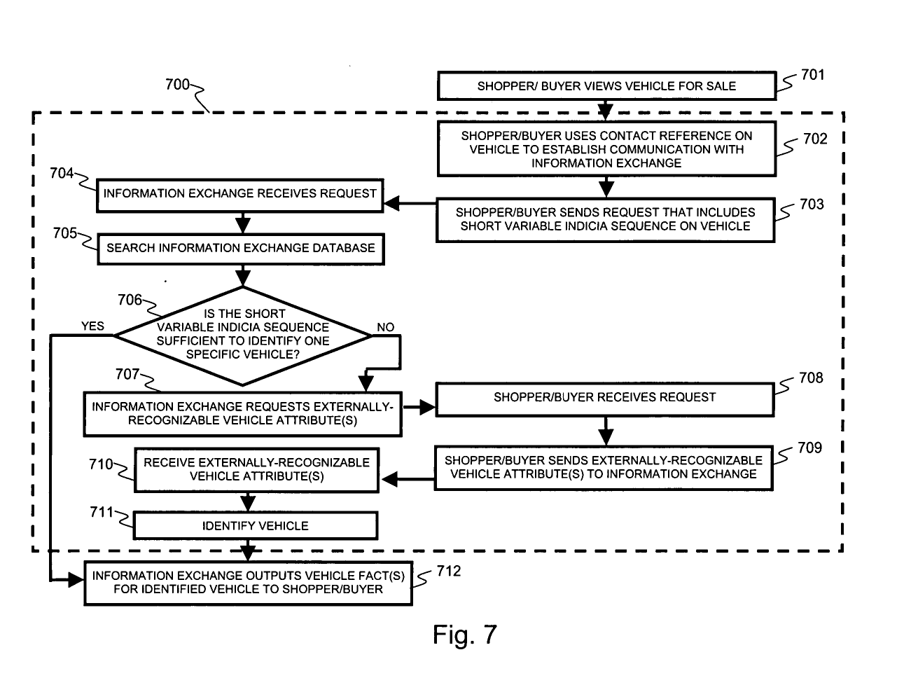

FIG. 7 shows a block diagram of a vehicle for sale inquiry process 700 that can be initiated by a shopper/buyer who has seen a vehicle for sale 701 and that can output vehicle fact(s) for a specific vehicle identified 712. The vehicle for sale inquiry process can include multiple transactions that occur between the shopper/buyer 406 and the information exchange 400 using one or more inquiry interfaces 404. Because the sign 110 can be large, the amount of information on the sign 110 can be minimized and simplified, and the vehicle 100 can move around, the advertising exposure of the vehicle for sale is maximized. This means that many inquiries can be generated.

In the vehicle for sale inquiry process 700, the shopper/buyer can use the contact reference 112 that he has seen on the vehicle for sale 100 to establish communication with the information exchange 400, a step shown at 702. The shopper/buyer can then send a request that includes the short variable indicia sequence 113 that he has seen on the vehicle for sale 110 to the information exchange, a step shown at 703. The information exchange 400 can receive this query, a step shown at 704. The controller 402 can then work with the database 401 to perform a search of all records that contain the short variable indicia sequence 113, a step shown at 705. The controller 402 can then make a determination of whether the short variable indicia sequence 113 is sufficient to identify one vehicle, a step shown at 706. If the result of decision step 706 is “YES”, the inquiry process 700 can be complete and the information exchange 400 can output at least one vehicle fact to the shopper/buyer 406, a step shown at 712.

If the result of decision step 706 is “NO”, the information exchange 400 can request one or more externally recognizable vehicle attribute(s) 502, a step shown at 707. An externally recognizable vehicle attribute 502 can be anything that a shopper/buyer 406 can ascertain about the vehicle by looking at the vehicle from the outside. Examples of externally recognizable vehicle attributes 502 are vehicle location 502-1, vehicle make 502-2, vehicle model 502-3, vehicle color 502-4, vehicle model year 502-5, a color or configuration of the sign 110 and a visual impression of a vehicle that can subsequently be matched to an image of the vehicle. Step 706 can be performed in many ways, some examples include, for example: (1) providing a series of images of vehicles that have the same short variable indicia sequence 113 and asking the shopper/buyer 406 to select the vehicle that most closely resembles the one seen; (2) requesting the location of the shopper/buyer 406 and identifying the vehicle that was registered in closest proximity to this location; and/or (3) requesting a vehicle color 502-3.

It is desirable that the short variable indicia sequence 113 is independent of the externally recognizable vehicle attributes 502. This maximizes the power of the combination of the short variable indicia sequence 113 and the externally recognizable vehicle attributes 502 to discriminate between the largest number of vehicles.

When the shopper/buyer 406 receives the request for externally recognizable vehicle attributes 502, a step shown at 708, through the query interface 404, the shopper/buyer 406 can send the information requested (one or more externally-recognizable vehicle attributes 502) to the information exchange, a step shown at 709. The information exchange 400 can then receive the one or more externally recognizable vehicle attributes 502, a step shown at 710. The information exchange 400 can then use the one or more externally recognizable vehicle attributes 502 and the previously-provided short variable indicia sequence 113 to identify a specific vehicle, a step shown at 711. This can complete the inquiry process 700. Thus, the query process can identify a specific vehicle and allow the information exchange 400 to output a vehicle fact 503 for the identified vehicle through the query interface 404, a step shown at 712.

When the shopper/buyer 406 uses the contact reference 112 in FIG. 1A or FIG. 1B to make a connection with the information exchange, 400 in FIG. 4A or FIG. 4B, and presents the short variable indicia sequence 113 displayed on the vehicle, and possibly also presents one or more externally recognizable vehicle attributes 502, the vehicle is identified and the shopper/buyer 406 can be provided with at least one vehicle fact 503 such as the vehicle price 503-1, the vehicle mileage 502-2, or the seller contact 502-3 to facilitate the sales process, without needing to divulge his interest in the vehicle to the seller 405. By providing an information exchange 400 that can be accessed 24 hours per day and 7 days per week, it can be easier for the shopper/buyer 406 of a vehicle 100 to gather information about the vehicle for sale. The shopper/buyer 406 of the vehicle 110 can also gather one or more vehicle facts 503 without having to express a relative degree of interest in the vehicle for sale 100.

In addition to the above elements depicted in the appended figures, other embodiments can also include:

A call center and/or call messaging support that identifies the car listed; takes voice messages; forwards messages to buyers and/or sellers; offers further information about the vehicle listed; and/or offers additional services that the buyer or seller may choose (for example, financing options, warranty options, detailed condition reports; pricing; bid process or offer).

A toll-free telephone listing that can offer toll-free support to either vehicle buyers, vehicle sellers or both.

Call center services that offer various services to listed parties, buyers, sellers, and shoppers such as detailed information, locate services, further identification services, and providing information related to listing, buying, selling, financing, appraising, servicing, detailing and negotiating the sale and purchase of motor vehicles.

Call center support to forward recorded responses, offers, and inquiries to sellers of listed vehicles and to process and forward replies to offers and inquiries by interested parties of listed vehicles.

An integrated website listing for the vehicle offered for sale with the website identification on the for sale sign. This website can serve as an electronic embodiment of an information exchange as well as identifying and integrating the various products, services, and listings described above. These services can also be delivered via VOIP (voice over internet protocol). The website can be a nationally or internationally recognized listing service for listings of private party (FSBO) For Sale By Owner vehicles. This website can allow various listing services to be integrated by displaying the For-Sale-Sign-System.

Listings and information downloadable to PDA (personal digital assistant) or a “smart phone” with messaging or internet capabilities.

The vehicle for sale sign can be sold as part of a kit that can include a CD-ROM and/or an interactive web site that can provide and promote:

Financing alternatives including financing links to selected lenders, both on-line and brick and mortar banks/Credit unions/finance companies, with whom the sign supplier has a relationship. The sign supplier can “screen” these lenders for integrity, competitive pricing and excellent customer service. These selected lenders may also pay the sign supplier referral fees for customers who come to them via the For Sale Kit. Also, the CD can include a tutorial on various financing alternatives, their respective pros and cons, and tips and hints as to how sellers, and their buyers, can best shop for and obtain financing.

Warranties including links to selected companies offering Extended Service Contracts with whom the sign supplier has a relationship. The sign supplier can “screen” these companies for integrity, competitive pricing and excellent customer service. These selected companies may also pay the sign supplier referral fees for customers who come to them via the For Sale Kit. In addition, the sign supplier can offer its own range of Extended Service Contracts, from an affiliated company. Also, the CD can include a tutorial on the types of coverage available, their respective pros and cons, and tips and hints as to how sellers, and their buyers, can best shop for and obtain extended service contracts. This can include a discussion of the marketing advantages to the Seller of offering a “warranty”.

Additional listing alternatives through various linked listing services (internet based listings, classified listings, magazine listings).

Pre-owned vehicle condition reports and certification services through strategic relationships with certification organizations for buyers or sellers of private party used cars (certifying the vehicle's condition) linked to other services, providing a stronger market for sellers and more peace of mind and availability for warranty protection for buyers of private party used cars. Vehicle histories and comparables through links to sites that provide vehicle history reports (CarFax™ and Equifax™, etc), as well as the many sites that give pricing and comparable sales info such as Kelly Blue Book™, NADA™, Edmunds™, and auction results. The CD can also provide a tutorial on the importance of research and careful analysis of market conditions, and market pricing, in order to achieve most advantageous sale.

Photo and video with single or multiple views and/or frames showing interior or exterior views of listed vehicles can be provided in analog or digital format or via the internet.

The system can provide instructions and downloads on how to include vehicle photographs along with the various listings that a customer may select. The customer can be invited to come to a store or licensed affiliate to have digital photos taken, and to have an agent structure the ad listing for the customer.

Provide information on how to sell and list a pre-owned vehicle. A pamphlet insert, inserted CD and linked website can explain in detail the how's and what-to-do's to prepare a used car for a private party listing. These services can include recommended services to perform and recommended companies to provide services and reconditioning. This how-to platform can assist in determining a proper selling price and strategies to best list the vehicle and obtain an optimum or quick sale.

Reconditioning services. The CD and website can be used to emphasize the importance of presenting a clean and well prepared vehicle for sale, and can offer both suggestions as to what the customer can do themselves, and third party vendors/services who can recondition the vehicle. These companies can be affiliated with the seller of the kit and/or they can be strategic partners, who will offer discounts to buyers of the kit or pay a referral fee to the supplier of the kits.

Appraisal services. Stores and licensed affiliates of the kit supplier can offer appraisal services—for a fee—to determine valuation. Customers can use these services for determining value for selling their vehicle. Appraisals are often obtained for insurance, litigation, and estate/probate uses.

Detailing services. The CD and website can emphasize the importance of presenting a clean and well prepared vehicle for sale, and can offer both suggestions as to what the customer can do themselves, and third party vendors/services who can recondition the vehicle. These companies can be affiliated with the seller of the kit, and/or strategic partners, who can offer discounts to buyers of the kit or pay a referral fee to the supplier of the kits.

Delivery services. It is possible to link the sales process to delivery services.

Transportation services. The CD and any website tools can identify affiliated and recommended companies to provide transportation of purchased vehicles for interstate and long distance transactions.

Intrastate and interstate titling services through companies that provide all the necessary services to complete vehicle transactions by providing complete and compliant title transfers. It can provide the necessary title transfer papers and documents that are compliant for the various state regulations.

Website creation support. The For-Sale-Kit can enable a customer to download a web based tool kit to develop a site for display of the listed vehicle with various descriptions of the car listed. It is possible to offer the customer a web template kit to create their own web listing and a listing that can be linked or exported to other listing companies such as eBay™.

Insurance. It is possible to offer insurance services for vehicle purchasers through affiliates, strategic partners, and sales agents.

Discounted products, services and affiliates can be offered much like Lending Tree™ and others provide a selection of affiliated links and strategic partners to enhance the purchasers outlay of resources to purchase desired services and products.

One-button web-based electronic multi-listings. It can deliver multiple possibilities for sellers to list their vehicles at various listing companies (web based, classified and magazine).

Broker/consulting services. In addition to brief tutorials on the CD itself on various buying and selling subjects, the CD can invite customers to come in to a store or licensed affiliate, where they can get personalized consultation from an agent as to how they can best achieve their particular objectives with respect to buying and/or selling a vehicle.

Third party negotiation services. It is possible to provide services that enable a seller and/or purchaser to deal through a third party negotiator. These services can be provided by agents, affiliates and licensed automotive brokers.

Contracts and forms creation that make it easy to print and complete desired and necessary forms for a proper sales transaction by using the CD or a web-based solution.

Auto-responder negotiations that enable the seller to auto respond to activity of the website listing. The auto responder will electronically respond via e-mail to an interested party's visit of a listed vehicle and notify the potential purchaser of various enhancements to the listed vehicle such as financing assistance, warranty availability, certification, etc.

Support for pricing strategies by having the seller and buyer compare pricing alternatives with affiliations of various resources such as Kelly Blue Book™, NADA™, and other valuation reports.

Auto-responder deal terms and buyer acceptance/refusal by automatically responding to a purchaser's offer of purchase or bid.

While the principles of the disclosure have been described above in connection with specific apparatuses and methods, it is to be clearly understood that this description is made only by way of example and not as limitation on the scope of the invention.

What is claimed is:

1. A sign that is machine producible and suitable for mounting on a window of a vehicle, the sign comprising:
a flexible substrate;
a first surface; and
a second surface, wherein:
the first surface faces the vehicle interior and the second surface faces the vehicle exterior when installed normally,
the second surface comprises:
at least one opaque area, and
at least one light transmitting area,
the at least one opaque area comprises first indicia and a second indicia,
the first indicia indicates that the vehicle is at least one of: for sale, for rent or for lease,
the second indicia uniquely distinguishes the sign from a plurality of similar signs, and
the sign has a visible light transmittance of at least 35% when an average is taken over the second surface.

2. The sign of claim 1, wherein the opaque area comprises a perforated material.

3. The sign of claim 1, wherein the light transmitting area is tinted.

4. The sign of claim 1, wherein the light transmitting area is a hole in a perforated material.

5. The sign of claim 1, wherein the at least one opaque area includes an area that a party using the sign can write contact information.

6. The sign of claim 1, wherein the at least one opaque area includes an area that a party using the sign can write contact information chosen from the group consisting of: a phone number, an e-mail address, a electronic message address, and a web address.

7. The sign of claim 1, wherein an area of the second surface is at least 100 square inches.

8. The sign of claim 1, the second indicia comprises information independent of the externally-recognizable vehicle attributes.

9. The sign of claim 1, wherein the sign further comprises a second substrate adjoining the substrate.

10. The sign of claim 1, wherein the substrate is of an average thickness of less than 0.100 inches.

11. The sign of claim 1, wherein the second indicia is visible from a minimum distance of 150 feet by a person with normal vision under normal daylight conditions.

12. The sign of claim 1, wherein the second indicia is user installable onto the second surface.

13. The sign of claim 1, wherein said the sign is installed on the vehicle, and the vehicle comprises a motor vehicle having a minimum of four wheels.

14. The sign of claim 1, wherein the second indicia comprise at least four independent elements, and each independent element of has a height or a width of at least 2.5 inches.

15. The sign of claim 1, wherein the second indicia are printed on the sign prior to the sign being sold to a retail customer.

16. The sign of claim 1, wherein the second indicia are adapted to be combined with the sign after retail sale of the sign.

17. The sign of claim 1, wherein the second indicia are written to the sign after retail sale of the sign.

18. The sign of claim 1, wherein the second indicia is used with a vehicle attribute from a group consisting of: vehicle location, vehicle make, vehicle model, vehicle color, vehicle year, and an image of the vehicle to discriminate between signs having identical second indicia.

19. The sign of claim 1, wherein the sign is in a configuration that meets local ordinances and state statutes for window tinting when applied to the window of the vehicle.

20. The sign of claim 1, wherein the sign further comprises a contact reference that uniquely identifies a location where the second indicia is associated with information on the vehicle.

21. The sign of claim 20, wherein the contact reference comprises at least one of a telephone number, an e-mail address, a web address, or a messaging address.

22. A sign for advertising availability of a vehicle for at least one of: for sale, for rent or for lease, the sign comprising:
a substrate sized for mounting at least partially on a window of the vehicle, wherein the substrate is flexible;
a first surface of the substrate that faces the vehicle when mounted normally;
a second surface of the sign that faces away from the vehicle when mounted normally;
a contact reference for positioning on the second surface or the vehicle, wherein the contact reference identifies a location where further information can be found that is accessible using the second indicia;
a first indicia on the second surface that indicates that the vehicle is at least one of: for sale, for rent or for lease; and
a second indicia for positioning on the second surface or the vehicle, wherein:
the second indicia comprises a code unique within a population of similar signs, and
the sign has a visible light transmittance of at least 35% averaged over a portion of the second surface that would normally be mounted on the window.

23. The sign of claim 22, wherein the substrate and at least one of the second indicia and the contact reference are separate items in a kit.

24. The sign of claim 22, wherein each indicium that is part of the second indicia comprises a minimum height of 2.5 inches and a minimum width of 0.5 inches.

25. The sign of claim 22, wherein the first indicia is readable at a distance of at least 250 feet by a person having normal vision under normal daylight conditions.

26. The sign of claim 22, wherein the sign has an average thickness of 0.100 inch or less.

27. The sign of claim 22, wherein the second indicia and the contact reference are attached on the second surface.

28. The sign of claim 22, wherein the sign has a minimum surface area of 125 square inches.

29. The sign of claim 22, wherein the vehicle comprises a motor vehicle having a minimum of four wheels.

30. The sign of claim 22, wherein the second indicia comprise a maximum of four characters.

31. The sign of claim 22, wherein the second indicia and an externally recognizable vehicle attribute from the group consisting of vehicle location, vehicle make, vehicle model, vehicle color, vehicle year, and an image of the vehicle are used to distinguish between signs having identical second indicia, but belong to different populations.

32. The sign of claim 22, wherein the contact reference comprises at least one of a telephone number, an e-mail address, a web address, or a messaging address.

33. A sign for mounting on a window of a vehicle, the sign comprising:
a flexible substrate, wherein the flexible substrate has:
a maximum average thickness of 0.600 inch,
a minimum surface area of 100 square inches, and
a visible light transmittance of at least 35% over at least 60% of a surface area of the substrate;
means for attaching the sign to the window, wherein the attaching means is integral to the sign;
characters that can be understood to indicate that the vehicle is at least one of for sale, for rent or for lease; and
a contact reference for locating an information exchange that automatically provides a textual information regarding the vehicle when contacted by an interested party.

34. The sign of claim 33, wherein the sign is attached to the vehicle.

35. The sign of claim 33, further comprising a license plate number on the vehicle that is supplied to the information exchange in a process to uniquely identify the sign from a population of signs.

36. The sign of claim 33, wherein:
the sign further comprises indicia, and
the indicia further comprise a maximum of four characters having a height of at least 2.5 inches each.

37. The sign of claim 36, wherein the indicia are printed on the sign prior to the sign being sold to a retail customer.

38. The sign of claim 36, wherein indicia are added on the sign by a purchaser of the sign.

39. The sign of claim 33, wherein the means for attaching includes an adhesive.

40. The sign of claim 33, wherein at least one of the contact reference or the characters is produced using an automated process and the characters being sufficiently durable to be readable even after two weeks of exposure to temperatures ranging from −40° F. to +120° F. and relative humidity ranging from 5% to 98%.

41. The sign of claim 33, wherein the vehicle comprises a motor vehicle having a minimum of four wheels.

42. The sign of claim 33, further comprising a code attached to the flexible substrate that is supplied to the information exchange in a process to uniquely identify the sign from a population of signs.

43. The sign of claim 33, wherein the source for further information regarding the sale of the vehicle comprises an information exchange.

44. The sign of claim 43, wherein the information exchange uses externally recognizable vehicle attributes from the group consisting of vehicle location, vehicle make, vehicle model, vehicle color, vehicle year, and an image of the vehicle to discriminate between signs having identical indicia.

45. A method for producing a sign for a vehicle, the method comprising steps of:
applying a contact reference on a surface of the vehicle, wherein the contact reference identifies a location where further information can be found that is accessible using the second indicia;
applying a first indicia on the surface of the vehicle that indicates that the vehicle is at least one of: for sale, for rent or for lease; and
applying a second indicia on the surface of the vehicle, wherein:
the second indicia comprises a code unique within a population of similar signs, and
the second indicia in combination with the contact reference can be used by a prospective purchaser to get information on the vehicle in an automated manner.

46. The method of claim 45, further comprising a step of applying the contact reference, the first indicia and the second indicia on a substrate before they are applied to the surface.

47. The method of claim 46, wherein the substrate passes at least 35% of incident visible light.

48. The method of claim 45, wherein automatically printing indicia comprises printing a maximum of four characters and wherein each character has a minimum height of 2.5 inches.

49. The method of claim 45, wherein the applying steps comprises a step of applying a solvent-based ink.

50. The method of claim 45, further comprising the steps of:
providing an electronic media;
providing a printed media; and
packaging the contact reference, the first indicia, the second indicia, the electronic media, and the printed media into a kit packaged for retail sale.
